(19) United States
(12) Patent Application Publication
(10) Pub. No.: US 2023/0407772 A1
(43) Pub. Date: Dec. 21, 2023

(54) CDA ROCKER ARM SYSTEM TO WHICH DUAL OIL SUPPLY LINE IS APPLIED AND METHOD OF CONTROLLING THE SAME

(71) Applicants: HYUNDAI MOTOR COMPANY, Seoul (KR); KIA CORPORATION, Seoul (KR)

(72) Inventor: Seung-Woo Shin, Hwaseong-si (KR)

(21) Appl. No.: 17/989,471

(22) Filed: Nov. 17, 2022

(30) Foreign Application Priority Data
Jun. 17, 2022 (KR) 10-2022-0074273

(51) Int. Cl. F01L 13/00; F01L 1/18

(52) U.S. Cl. CPC F01L 13/0005; F01L 1/181; F01L 2013/001

(57) ABSTRACT

A CDA rocker arm system to which a dual oil supply line is applied uses an oil supply line comprised of a primary oil line connected from an OCV to one side of a rocker pin to supply the oil and a secondary oil line connected from the OCV to the other side of the rocker pin to supply the oil, and opens the primary oil line and blocks the secondary oil line when a control unit operates a cylinder deactivation (CDA) under the control of the OCV, whereas the CDA rocker arm system opens the secondary oil line and blocks the primary oil line when the CDA is not operated, so that the rocker pin may be converted into the pin disengaged and pin engaged states by the hydraulic operation of the oil supplied in both cases in which the CDA is operated and not operated under an oil supply direction control of the OCV.

### CROSS REFERENCE TO RELATED APPLICATIONS

This application claims priority to Korean Patent Application No. 10-2022-0074273, filed on Jun. 17, 2022, which is incorporated herein by reference in its entirety.

### BACKGROUND

### Field of the Disclosure

The present disclosure relates to a CDA rocker arm system, and in particular, to a CDA rocker arm system to which a dual oil supply line of primary and secondary oil lines, which can prevent a pin slip by supplying an oil to form a hydraulic pressure for moving and returning a pin position of an OCV, is applied and a method of controlling the same.

### Description of Related Art

In general, a cylinder deactivation (CDA) system is a rocker arm that is mounted on each cylinder of an engine and operated by a hydraulic pressure supplied when a CDA is operated and converts a corresponding cylinder to a deactivated state.

To this end, the CDA system comprises a rocker arm device, and the rocker arm device includes a rocker arm, a rocker pin positioned inside a rocker arm mechanism, and an oil control valve (hereinafter referred to as OCV) configured to control the oil supply to the rocker pin from an outside of the rocker arm.

For example, the rocker pin is comprised of an actuation pin, an inner pin, a latch pin, and a spring linearly arranged, and the pins (i.e., the inner pin and the latch pin) are moved and the spring is compressed by the oil supply of the OCV to an internal space when the CDA is operated (i.e., ON) whereas the positions of the pins (i.e., the inner pin and the latch pin) are returned by a restoring force of the spring against the hydraulic pressure that weakens as the oil is discharged from the internal space through a fine gap formed in an internal mechanism of the rocker arm by blocking the oil of the OCV when the CDA is not operated (i.e., OFF).

In other words, an oil is supplied to an oil control circuit through a rocker shaft oil line of the rocker arm when the CDA is operated, and the actuation pin pushed by the increase in hydraulic pressure moves the pins (i.e., the inner pin and the latch pin), so that the rocker pins are converted into a disengaged state to cause a lost motion in which an inner rocker arm of inner/outer rocker arms of the rocker arm is separated so that the corresponding cylinder is in a deactivated state. In addition, the rocker pin is converted into an engaged state as the inner pin is returned back to an original position by a spring restoring force that acts as large as a reduction in the hydraulic pressure due to the discharge of the oil returning to the OCV in a state in which the oil supply is stopped when the CDA is not operated, so that the corresponding cylinder is operated.

However, in order to prevent a problem with CDA operability in the rocker pin when the CDA is operated, the accuracy of the pin position control is inevitably required because the lost motion is implemented by moving the positions of the pins (i.e., the inner pin and the latch pin) inside the mechanism of the rocker arm.

Accordingly, the rocker pin intermittently causes the pin slip phenomenon when an internal structural environment of the rocker arm is a low friction condition when the pin position is moved by using the hydraulic pressure, and the pin slip unnecessarily causes lost motion, thereby acting as one reason that causes a functional problem and reduces engine performance efficiency.

In particular, a spring applied to the rocker pin provides a spring restoring force, but this has a fundamental limitation in that the spring pushes the latch pin when the hydraulic pressure is removed due to the non-operation of the CDA, so that a pin binding force for being engaged with the inner pin is not sufficient.

The contents described in Description of Related Art are to help the understanding of the background of the present disclosure, and may include what is not previously known to those skilled in the art to which the present disclosure pertains.

### SUMMARY

Accordingly, an object of the present disclosure considering the above points is to provide a CDA rocker arm system to which a dual oil supply line, which may perform the conversion between pin disengaged and pin engaged states of a rocker pin by supplying an oil to the rocker pin both in cases in which a CDA is operated and not operated under an opening/closing control of a primary oil line and a secondary oil line by a hydraulic pressure, and in particular, can prevent a pin slip by strengthening a pin binding force of the rocker pin by using a spring restoring force for securing a primary pin engagement and using a hydraulic operation for securing a secondary pin engagement, is applied, and a method of controlling the same.

In order to achieve the object, a CDA rocker arm system according to the present disclosure comprises a rocker arm, a rocker pin configured to generate a lost motion of the rocker arm for CDA by a hydraulic operation of an oil. an OCV configured to control the oil, an oil supply line comprised of a primary oil line connected from the OCV to one side of the rocker arm to supply the oil, and a secondary oil line connected from the OCV to the other side of the rocker arm to supply the oil, and a control unit configured to control the OCV by opening the primary oil line and blocking the secondary oil line when the CDA is operated, and control the OCV by opening the secondary oil line and blocking the primary oil line when the CDA is not operated.

In one embodiment, the rocker pin includes an actuation pin, an inner pin, and a latch pin positioned on a rocker arm boss of the rocker arm, the actuation pin is positioned at one side of the rocker arm to receive the oil from the primary oil line, the inner pin is positioned between the actuation pin and the latch pin, and the latch pin is positioned at the other side of the rocker arm to receive the oil from the secondary oil line.

In an embodiment, the secondary oil line pushes the latch pin toward the inner pin by supplying the oil according to the non-operation of the CDA, and the inner pin releases the lost motion of the rocker arm in a pin engaged state.

in an embodiment, the secondary oil line supplies a magnitude of a hydraulic pressure at which a hydraulic pressure of the oil pushes the latch pin as a reference hydraulic pressure, and the reference hydraulic pressure is set to be reduced by a spring restoring force applied to the latch pin, and the spring restoring force is generated by a spring configured to elastically support the latch pin between a left plug closing an opening of the rocker arm boss and the latch pin.

In an embodiment, the primary oil line pushes the actuation pin toward the inner pin by supplying the oil according to the operation of the CDA, and the inner pin generates the lost motion of the rocker arm in a pin disengaged state.

In an embodiment, the oil dual supply line further includes a bypass oil line, and the bypass oil line returns the oil supplied from the primary oil line and the secondary oil line to the rocker pin from the rocker pin toward the OCV.

In an embodiment, the rocker arm is comprised of an inner rocker arm and an outer rocker arm connected by the rocker pin, and upon the lost motion of the rocker arm, the inner rocker arm is separated from the outer rocker arm so that the operation of the CDA is performed.

In addition, in order to achieve the object, in a method of controlling a CDA rocker arm system, wherein an operation of a CDA operation by a control unit includes operating an OCV by a CDA ON signal output, supplying an oil to one side of a rocker arm by blocking a secondary oil line and opening a primary oil line, moving an actuation pin of a rocker pin by a hydraulic operation of the oil, forming a pin disengaged state of an inner pin of the rocker pin by the hydraulic operation, separating an outer rocker arm and an inner rocker arm of the rocker arm, and implementing a lost motion by the inner rocker arm.

In an embodiment, an operation of a non-operation of the CDA by the control unit includes stopping an operation of the OCV by a CDA OFF signal output, blocking the oil supply to one side of the rocker arm by blocking the primary oil line, releasing a hydraulic pressure of the oil from the actuation pin of the rocker pin; moving a latch pin of the rocker pin by a spring restoring force of a spring, forming a primary pin engaged state of the inner pin of the rocker pin as the inner pin of the rocker pin is pushed to an initial position by the latch pin, supplying the oil to the other side of the rocker arm by opening the secondary oil line, moving the latch pin by the hydraulic operation of the oil, and forming a secondary pin engaged state of the inner pin whose binding force is strengthened by the hydraulic operation.

In an embodiment, an operation of a non-operation of the CDA by the control unit includes stopping an operation of the OCV by a CDA OFF signal output, blocking the oil supply to one side of the rocker arm by blocking the primary oil line, releasing a hydraulic pressure of the oil from the actuation pin of the rocker pin, supplying the oil to the other side of the rocker arm by opening the secondary oil line, moving the latch pin by the hydraulic operation of the oil, and forming a pin engaged state of the inner pin of the rocker pin at an initial position by the hydraulic operation.

The CDA rocker arm system to which the dual oil supply line is applied according to the present disclosure implements the following operations and effects.

First, it is possible to prevent the pin slip by performing the hydraulic operation both in the cases in which the pin position of the rocker pin is moved and returned even when the rocker pin is in the internal structural environment of the low friction condition. Second, it is possible to very effectively prevent the pin slip of the rocker pin by adding the oil bypass line at the left of the rocker arm together with the oil supply line at the right of the rocker arm and the hydraulic pressure is operated for the pin movement both in the cases in which the CDA is operated and not operated. Third, it is possible to strengthen the pin binding force for preventing the pin slip by the primary engagement of the pin due to the spring restoring force generated by releasing the hydraulic pressure at the right of the rocker arm when the CDA is not operated and the secondary engagement of the pin due to the generation of the hydraulic pressure at the left of the rocker arm. Fourth, it is possible to not only solve the functional problem of the rocker arm system as the pin slip is prevented in the rocker pin by strengthening the pin binding force, but also improve merchantability through the improvement in performance of the engine to which the solution to the functional problem is applied.

### BRIEF DESCRIPTION OF THE FIGURES

FIG. 1 is a configuration diagram of a CDA rocker arm system to which a dual oil supply line is applied according to the present disclosure.

FIG. 2 shows an example of a layout in which the dual oil supply line according to the present disclosure is actually applied.

FIG. 3 shows an operation state in which a rocker pin is disengaged by an oil hydraulic pressure at a primary oil line of the dual oil supply line when a CDA is operated in a method of controlling the CDA rocker arm system according to the present disclosure.

FIG. 4 shows an operation state in which the rocker pin is engaged by an oil hydraulic pressure at a secondary oil line under an operation of a spring restoring force when the CDA is not operated in the method of controlling the CDA rocker arm system according to the present disclosure.

FIG. 5 shows an operation state in which the rocker pin is engaged by only the oil hydraulic pressure at the secondary oil line without the spring restoring force when the CDA is not operated in the method of controlling the CDA rocker arm system according to the present disclosure.

### DETAILED DESCRIPTION

Hereinafter, embodiments of the present disclosure will be described in detail with reference to the accompanying exemplary drawings, and the embodiments are illustrative and may be implemented in various different forms by those skilled in the art to which the present disclosure pertains, and thus not limited to the embodiments described herein.

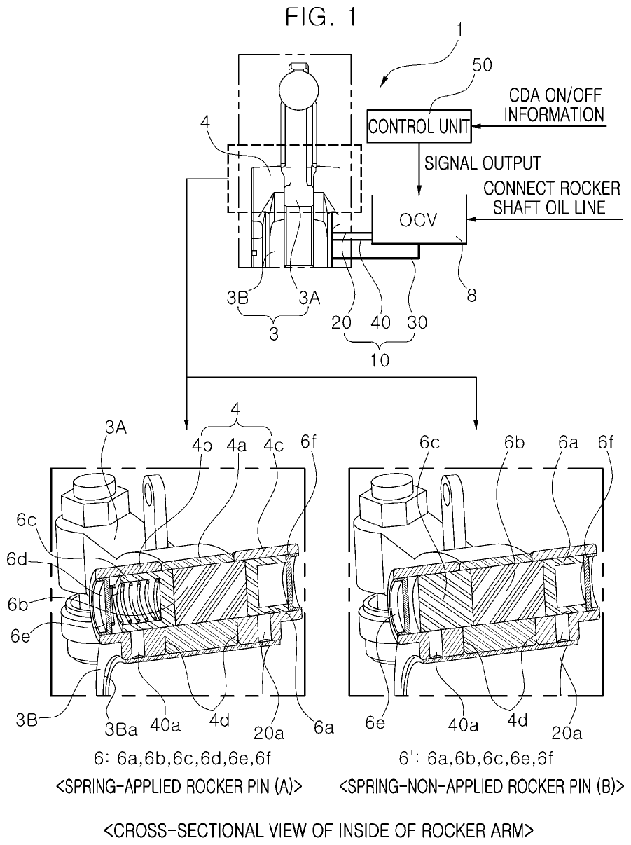

Referring to FIG. 1, a cylinder deactivation (CDA) rocker arm system 1 includes a rocker arm 3, a rocker pin 6, an oil control valve (OCV) 8, and an oil supply line 10. In this case, a cylinder deactivation (CDA) is installed on each cylinder of an engine and converts a corresponding cylinder into a deactivated state at operation.

In particular, the oil supply line 10 is dualized as a primary oil line 20 and a secondary oil line 40 in order to form a hydraulic pressure for the rocker pin 6, thereby generating a hydraulic operation in both cases in which the CDA is operated and not operated.

Accordingly, the CDA rocker arm system 1 is characterized by a CDA rocker arm system to which an oil dual supply circuit, which can prevent the occurrence of the pin slip of the rocker pin 6 by maintaining the engagement state of the rocker pin 6, which restores the lost motion of the rocker arm when the CDA is not operated with a strong binding force by the hydraulic pressure, is applied.

Specifically, the oil supply line 10 is formed inside the rocker arm 3 (i.e., an outer rocker arm 3B) and is comprised of a primary oil line 20, a bypass oil line 30, and a secondary oil line 40, which are connected to an OCV 8.

For example, the primary oil line 20 is drilled from the OCV 8 to one side of the rocker pin 6 coupled to the rocker arm 3 by passing through an inside of the rocker arm 3, so that the oil is supplied to an actuation pin 6a of the rocker pin 6 coupled to the rocker arm 3 from the OCV 8 to form a hydraulic circuit when the CDA is operated. The bypass oil line 30 returns all oils discharged from an oil discharge gap 4d of a rocker arm boss 4 toward the OCV 8. In this case, the primary oil line 20 and the bypass oil line 30 are components of a basic oil circuit of the OCV 8.

For example, the secondary oil line 40 is drilled from the OCV 8 to the other side of the rocker pin 6 coupled to the rocker arm 3 by passing through an inside of the rocker arm 3, so that the oil is supplied to a latch pin 6c of the rocker pin 6 coupled to the rocker arm 3 from the OCV 8 to form a hydraulic circuit when the CDA is not operated.

Accordingly, the oil supply line 10 may allow the rocker pin 6 to be comprised of a spring-applied rocker pin (A) or a spring-non-applied rocker pin (B) by the hydraulic operation by the secondary oil line 40. In this case, the hydraulic pressure of the oil supplied from the secondary oil line 40 is supplied by setting a magnitude of a hydraulic pressure that pushes the latch pin 6c as a reference hydraulic pressure, and the reference hydraulic pressure is set to decrease by the spring restoring force of a spring 6d applied to the latch pin 6c.

For example, in the spring-applied rocker pin (A), as the component of the rocker pin 6, the actuation pin 6a, the inner pin 6b, the latch pin 6c, the spring 6d, a left plug 6e, and a right plug 6f are applied, and a return force that returns the latch pin 6c when the CDA is not operated is formed by the sum of a spring pressurization force and the hydraulic pressure.

On the other hand, in the spring-non-applied rocker pin (B), as a component of a modified rocker pin 6′, the actuation pin 6a, the inner pin 6b, the latch pin 6c, the spring 6d, the left plug 6e, and the right plug 6f are applied, and the return force for returning the latch pin 6c when the CDA is not operated is formed by only the hydraulic pressure.

As described above, the formation of the hydraulic pressure is added to the rocker pin 6 and the modified rocker pin 6′ through the secondary oil line 40 connected toward the latch pin 6c, so that the spring 6d may not be applied like the spring-non-applied rocker pin (B) compared to the spring-applied rocker pin (A).

In particular, the modified rocker pin 6′ of the spring-non-applied rocker pin (B) sets the oil hydraulic pressure supplied from the secondary oil line 40 to a reference bypass hydraulic pressure of 100%, whereas the rocker pin 6 of the spring-applied rocker pin (A) sets the oil hydraulic pressure supplied from the secondary oil line 40 to the reference bypass hydraulic pressure of 50 to 70% according to the magnitude of the spring pressurization force. In this case, a range of 50 to 70% of the reference bypass hydraulic pressure may be set to have an area having a larger or smaller magnitude of the spring pressurization force.

Specifically, the rocker arm 2 converts the corresponding cylinder to the deactivated state with the lost motion when the CDA is operated, and the rocker pin 6 is coupled by using the rocker arm boss 4. In this case, a cam of a camshaft is positioned at the one end of the rocker arm 3 thereunder, and an engine bridge configured to operate engine valves (i.e., an intake valve and an exhaust valve) mounted on the cylinder of the engine is positioned at the other end of the rocker arm 3 thereunder. In this case, the rocker arm 3 is connected to the rocker shaft oil line to form an oil flow supplied toward the rocker pin 6 and an oil flow returned from the rocker pin 6 side, and the rocker shaft oil line is a component of a general rocker arm.

For example, the rocker arm 3 has a separate structure of an inner rocker arm 3A and an outer rocker arm 3B, wherein the inner rocker arm 3A forms an intermediate boss 4a, and the outer rocker arm 3B forms a left boss 4b and a right boss 4c.

For example, the rocker arm boss 4 is comprised of an intermediate boss 4a, a left boss 4b, and a right boss 4c, wherein the left boss 4b forms a rocker arm left section (i.e., position at the latch pin 6c side of the rocker pin 6) with respect to the intermediate boss 4a, and the right boss 4c forms a rocket arm right section (i.e., position at the actuation pin 6a side of the rocker pin 6) with respect to the intermediate boss 4a.

In particular, the oil discharge gap 4d is formed in the rocker arm boss 4 through a contact surface between the intermediate boss 4a and the left boss 4b and a contact surface between the intermediate boss 4a and the right boss 4c, and the oil discharge gap 4d is introduced into the rocker arm boss 4 side through the primary oil line 20 of the oil supply line 10 when the CDA is operated to discharge and send the oil filled in a pin hole space to the bypass oil line 30. In this case, the oil discharge gap 4d is configured as a fine gap to the extent that the oil is discharged.

Accordingly, the rocker arm 3 is coupled in a state in which the intermediate boss 4a of the inner rocker arm 3A is surrounded by the left/right bosses 4b and 4c of the outer rocker arm 3B, so that the rocker pins 6 are linearly arranged through pin holes of the rocker arm boss 4 linearly communicating with each other.

Specifically, the rocker pin 6 is comprised of the actuation pin 6a, the inner pin 6b, the latch pin 6c, the spring 6d, the left plug 6e, and the right plug 6f.

For example, the actuation pin 6a is coupled to the pin hole of the right boss 4c of the outer rocker arm 3B and positioned in the rocker arm right section, and connected to the primary oil line 20 of the oil supply line 10, the inner pin 6b is coupled to the pin hole of the intermediate boss 4a of the inner rocker arm 3A and positioned in a rocker arm intermediate section, and the latch pin 6c is coupled to the pin hole of the left boss 4b of the outer rocker arm 3B and positioned in the rocker arm left section, and connected to the secondary oil line 40 of the oil supply line 10.

Accordingly, the actuation pin 6a, the inner pin 6b, and the latch pin 6c are linearly arranged through the pin hole of the rocker arm boss 4 of the rocker arm 2, and the actuation pin 6a moves the inner pin 6b by the hydraulic operation to convert the rocker pin 6 into the disengaged state when the CDA is operated, whereas the latch pin 6c moves the inner pin 6b in an opposite direction by the hydraulic operation when the CDA is not operated to convert the rocker pin 6 to the engaged state.

For example, the spring 6d elastically supports the latch pin 6c, and pushes the latch pin 6c in the opposite direction by an elastic force of the spring as it is compressed by the pressurization force caused by the pushed movement of the latch pin 6c when the CDA is operated, and is tensioned when the pressurization force of the latch pin 6c is released by the non-operation of the CDA. In this case, the spring 6d is received in a “U” cross-sectional structure of the latch pin 6c.

For example, the plugs 6e and 6f are classified into the left plug 6e and the right plug 6f, wherein the left plug 6e is inserted into an opening of the left boss 4b of the outer rocker arm 3B to make the pin hole of the left boss 4b a sealed space to elastically support one portion of the spring 6d, and the right plug 6f is fitted into an opening of the right boss 4c of the outer rocker arm 3B to make the pin hole of the right boss 40 a sealed space. In this case, each of the left/right plugs 6e and 6f may be fixed by press-fitting or welding.

Specifically, the OCV 8 is connected to the rocker shaft oil line to control the oil supply to the rocker pin 6 from an outside of the rocker arm 3, and opens and closes the primary oil line 20, the bypass oil line 30, and the secondary oil line 40 of the oil supply line 10 under a control of a control unit 50 so that a hydraulic circuit according to the operation and non-operation of the CDA is formed.

Specifically, the control unit 50 controls the opening and closing of the OCV 8 to form oil supply and blocking circuits for the primary oil line 20, the bypass oil line 30, and the secondary oil line 40 of the oil supply line 10. To this end, the control unit 50 generates CDA ON/OFF information based on vehicle traveling conditions or engine control states, and controls the OCV 8 with a CDA ON signal output and a CDA OFF signal output depending on whether the CDA is controlled. In this case, the control unit 50 may be a separate dedicated control unit, but an engine control unit.

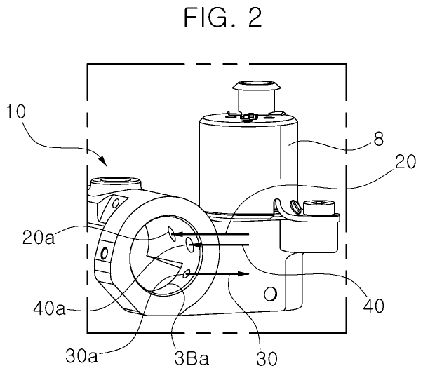

Referring to FIG. 2, the oil supply line 10 communicates with an outer rocker bore 3Ba configuring the outer rocker arm 3B of the rocker arm 3 through first, second, and third opening holes 20a, 30a, and 40a. In this case, the outer rocker bore 3Ba couples a rocker shaft surrounded by a bearing or a bush, and a main oil line and a sub-oil line of the rocker shaft oil line that supplies an oil toward the OCV 8 are formed on the rocker shaft. In this case, the rocker shaft oil line receives the oil from an oil gallery.

For example, among the first, second, and third opening holes 20a, 30a, and 40a, the first opening hole 20a forms an oil inlet of the primary oil line 20 to function as an inlet in which the oil supplied from the OCV 8 enters the primary oil line 20, the second opening hole forms an oil inlet of the bypass oil line 30 to function as an inlet through which the oil discharged from the rocker arm boss 4 through the oil discharge gap 4d enters the bypass oil line and the third opening hole 40a forms an oil inlet of the secondary oil line 40 to function as an inlet in which the oil supplied from the OCV 8 enters the secondary oil line 40.

In particular, the primary oil lines 20 and the secondary oil lines 40 are alternately arranged at separation intervals, and the bypass oil lines 30 are arranged at separation intervals under the primary and secondary oil lines 20 and 40.

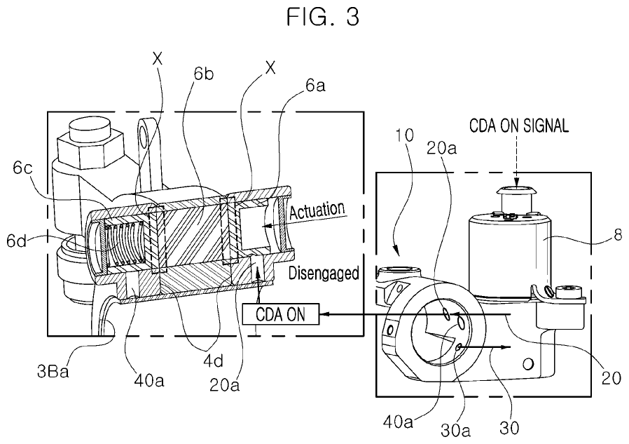

Meanwhile, FIGS. 3 to 5 show an operation of the CDA rocker arm system 1 by a control method of the control unit 50. In this case, a control subject is the control unit 50, and a control object is the OCV 8.

Referring to the operation of the CDA in FIG. 3, when the CDA is operated by the CDA ON signal of the control unit 50, the OCV 8 opens the primary oil line 20 while blocking the secondary oil line 40, so that the primary oil line 20 forms a CDA ON state.

Accordingly, the first oil line 20 uses the first opening hole 20a as the oil inlet to receive the oil supplied from the rocker shaft oil line of the rocker arm 3 and fill the oil in the right boss 4c of the rocker arm boss 4, the actuation pin 6a of the rocker pin 6 is pushed from the right and the left by an actuation operation by the hydraulic pressure of the oil filled in the right boss 4c, and the inner pin 6b moves the latch pin 6c from the right to the left while moving with the actuation pin 6a. In this case, the state of the spring 6d is converted into a compressed state by the pushed movement of the latch pin 6c.

As a result, the inner pin 6b matches the intermediate boss 4a of the rocker arm boss 4, the actuation pin 6a matches the right boss 4c, and the latch pin 6c matches the left boss 4b, so that the inner rocker arm 3A and the outer rocker arm 3B are in a separated state as a pin disengaged state (X) in which the left/right end portions of the inner pin 6b match the left/right oil discharge gaps 4d, and the separated state of the rocker arm 3 generates the lost motion and thus the corresponding cylinder is converted into the deactivated state. In this case, the bypass oil line 30 functions to more quickly send the oil discharged from the left/right oil discharge gaps 4d to the OCV 8 due to the pin disengaged state (X) to be returned toward the oil gallery of the engine.

As described above, in the operation of the CDA, the CDA rocker arm system 1 is operated in the order of “(1) the operation of the OCV->(2) the oil supply to the right of the rocker arm->(3) movement of the actuation pin->(4) the pin disengaged->(5) the separation of the inner rocker arm->(6) implementation of the lost motion of the inner rocker arm”. In this case, “->” is the proceeding order of operation.

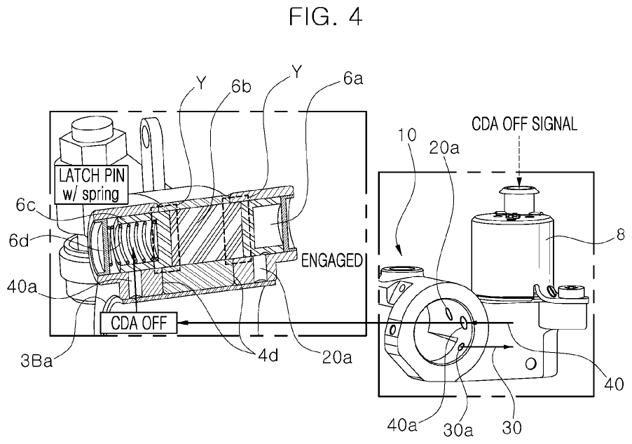

On the other hand, referring to the non-operation of the CDA of the spring-applied rocker pin (A) type rocker pin 6 in FIG. 4, when the CDA is not operated by the CDA OFF signal of the control unit 50, the OCV 8 opens the secondary oil line 40 while blocking the primary oil line 20, so that the secondary oil line 40 forms the CDA OFF state.

Accordingly, the spring 6d generates the spring restoring force by releasing the oil pressure of the primary oil line 20 to apply the spring pressing force to the latch pin 6b of the rocker pin 6.

Accordingly, the secondary oil line 40 uses the second opening hole 20b as the oil inlet to receive the oil supplied from the rocker shaft oil line of the rocker arm 3 and fill the oil in the left boss 4b of the rocker arm boss 4, the latch pin 6b of the rocker pin 6 is pushed from the left and the right by the hydraulic operation of the oil filled in the left boss 4b together with the spring pressurization force of the spring 6d, and the inner pin 6b moves the actuation pin 6a from the left to the right while moving with the latch pin 6b. In this case, the spring pressurization force and the hydraulic operation increase the pin binding force in the pin engaged state, so that the slip phenomenon of the rocker pin 6 hardly occurs or is prevented.

As a result, the latch pin 6c moves out of the left boss 4b to the intermediate boss 4a, the inner pin 6b moves out of the intermediate boss 4a to the right boss 4c, and the actuation pin 6a is moved to an inside of the right boss 4c, so that the inner rocker arm 3A and the outer rocker arm 3B are in a connected state as the pin engaged state (Y) in which the left/right end portions of the inner pin 6b are misaligned with the left/right oil discharge gaps 4d, and the connection of the rocker arm 3 converts the corresponding cylinder into a combustion state. In this case, the bypass oil line 30 functions to send the oil discharged from the left/right oil discharge gaps 4d to the OCV 8 to be returned toward the oil gallery of the engine.

As described above, in the non-operation or stoppage of the CDA of the spring-applied rocker pin (A), the CDA rocker arm system 1 is operated in the order of “(1) the non-operation of the OCV->(2) the blocking of rocker arm right oil->(3) release of the hydraulic pressure of the actuation pin->(4) pin engaged by the spring->(5) the oil supply to the left of the rocker arm->(6) supply of the hydraulic pressure to the latch pin->(7) pin engaged and strengthen the binding force by the hydraulic pressure”. In this case, “->” is the proceeding order of operation.

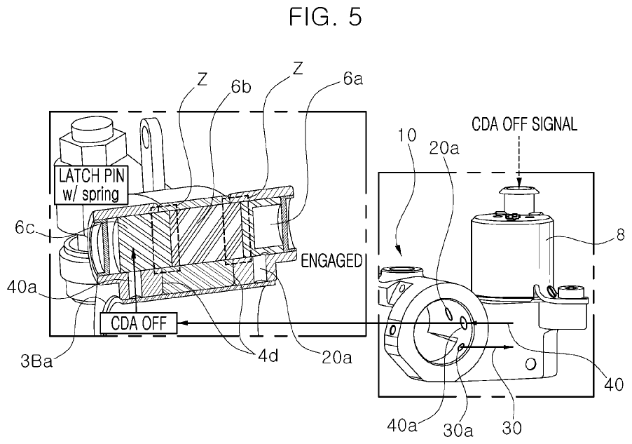

In addition, referring to the non-operation/stoppage of the CDA of the spring-non-applied rocker pin (B) type modified rocker pin 6′ in FIG. 5, when the CDA is not operated by the CDA OFF signal of the control unit 50, the OCV 8 opens the secondary oil line 40 while blocking the primary oil line 20, so that the secondary oil line 40 forms the CDA OFF state. In this case, the spring-non-applied rocker pin (B) does not use the spring 6d, and thus is in a state in which there is no generation of the spring restoring force due to the compression of the spring by the hydraulic pressure supply of the primary oil line 20 and the blocking of the hydraulic pressure of the primary oil line 20.

Accordingly, the left boss 4b of the rocker arm boss 4 is filled with the oil received through the second opening hole 20b of the secondary oil line 40, so that the latch pin 6b of the rocker pin 6 is pushed from the left to the right by the hydraulic operation of the oil, and the inner pin 6b moves the actuation pin 6a from the left to the right while moving with the latch pin 6b. In this case, the hydraulic operation increases the pin binding force in the pin engaged state with the magnitude of the hydraulic pressure that supplements the magnitude of the spring pressurization force, so that the slip phenomenon of the rocker pin 6 hardly occurs or is prevented.

As a result, the latch pin 6c moves out of the left boss 4b to the intermediate boss 4a, the inner pin 6b moves out of the intermediate boss 4a to the right boss 4c, and the actuation pin 6a is moved to an inside of the right boss 4c, so that the inner rocker arm 3A and the outer rocker arm 3B are in a connected state as a pin engaged state (Z) in which the left/right end portions of the inner pin 6b are misaligned with the left/right oil discharge gaps 4d, and the connection of the rocker arm 3 converts the corresponding cylinder into a deactivated state. In this case, the bypass oil line 30 functions to send the oil discharged from the left/right oil discharge gaps 4d to the OCV 8 to be returned toward the oil gallery of the engine.

As described above, in the non-operation/stoppage of the CDA of the spring-non-applied rocker pin (B), the CDA rocker arm system (1) is operated in the order of “(1) non-operation of the OCV->(2) blocking of the rocker arm right oil->(3) release of the hydraulic pressure of the actuation pin->(4) oil supply to the left of the rocker arm->(5) hydraulic pressure supply to the latch pin->(6) pin-engaged by the hydraulic pressure and strengthen the pin binding force by the hydraulic pressure”. In this case, “->” is the proceeding order of operation.

As described above, the CDA rocker arm system 1 to which the dual oil supply line is applied according to this embodiment uses the oil supply line 10 comprised of the primary oil line 20 connected from the OCV 8 to one side of the rocker pin 6 or the modified rocker pin 6′ to supply the oil and the secondary oil line 40 connected from the OCV 8 to the other side of the rocker pin 6 or the modified rocker pin 6′ to supply the oil, and opens the primary oil line 20 and blocks the secondary oil line 40 when the control unit 50 operates the cylinder deactivation (CDA) under the control of the OCV 8, whereas opening the secondary oil line 40 and blocking the primary oil line 20 are performed when the CDA is not operated, so that the rocker pin 6 may be converted into the pin disengaged and pin engaged states by the hydraulic operation of the oil supplied in both cases in which the CDA is operated and not operated under an oil supply direction control of the OCV 8, and in particular, it is possible to prevent the pin slip by strengthening the pin binding force by using the spring restoring force for securing the primary pin engagement and using the hydraulic operation for securing the secondary pin engagement.

While a number of exemplary aspects and embodiments have been discussed above, those of skill in the art will recognize that still further modifications, permutations, additions and sub-combinations thereof of the features of the disclosed embodiments are still possible. It is therefore intended that the following appended claims and claims hereafter introduced are interpreted to include all such modifications, permutations, additions and sub-combinations as are within their true spirit and scope.

1. A CDA rocker arm system comprising:
a rocker arm;
a rocker pin configured to generate a lost motion of the rocker arm for cylinder deactivation (CDA) by a hydraulic operation of an oil;
an oil control valve (OCV) configured to control the oil;
an oil supply line comprised of a primary oil line connected from the OCV to one side of the rocker arm to supply the oil, and a secondary oil line connected from the OCV to an other side of the rocker arm to supply the oil; and
a control unit configured to control the OCV by opening the primary oil line and blocking the secondary oil line when the CDA is operated, and control the OCV by opening the secondary oil line and blocking the primary oil line when the CDA is not operated;
wherein the oil supply line further includes a bypass oil line; and
wherein the bypass oil line returns the oil supplied from the primary oil line and the secondary oil line to the rocker pin from the rocker pin toward the OCV.

2. The CDA rocker arm system of claim 1, wherein the rocker pin includes an actuation pin, an inner pin, and a latch pin positioned on a rocker arm boss of the rocker arm;
wherein the actuation pin is positioned at one side of the rocker arm and configured to receive the oil from the primary oil line;
wherein the inner pin is positioned between the actuation pin and the latch pin; and
wherein the latch pin is positioned at an other side of the rocker arm and configured to receive the oil from the secondary oil line.

3. The CDA rocker arm system of claim 2, wherein the secondary oil line is configured to push the latch pin toward the inner pin by supplying the oil according to a non-operation of the CDA, and the inner pin is configured to release the lost motion of the rocker arm in a pin-engaged state.

4. The CDA rocker arm system of claim 3, wherein the secondary oil line is configured to supply a magnitude of a hydraulic pressure at which a hydraulic pressure of the oil pushes the latch pin as a reference hydraulic pressure, and the reference hydraulic pressure is set as small as a spring restoring force applied to the latch pin.

5. The CDA rocker arm system of claim 4, wherein the spring restoring force is generated by a spring configured to elastically support the latch pin between a left plug closing an opening of the rocker arm boss and the latch pin.

6. The CDA rocker arm system of claim 2, wherein the primary oil line is configured to push the actuation pin toward the inner pin by supplying the oil according to an operation of the CDA, and the inner pin is configured to generate the lost motion of the rocker arm in a pin-disengaged state.

7. (canceled)

8. The CDA rocker arm system of claim 1, wherein the rocker arm is comprised of an inner rocker arm and an outer rocker arm connected by the rocker pin, and
upon the lost motion of the rocker arm, the inner rocker arm is separated from the outer rocker arm so that the operation of the CDA is performed.

9. A method of controlling a cylinder deactivation (CDA rocker arm system as defined in claim 1,
wherein an operation of a CDA operation, by a control unit, includes:
operating an OCV by a CDA ON signal output;
supplying an oil to one side of a rocker arm by blocking a secondary oil line and opening a primary oil line;
moving an actuation pin of a rocker pin by a hydraulic operation of the oil;
forming a pin-disengaged state of an inner pin of the rocker pin by the hydraulic operation;
separating an outer rocker arm and an inner rocker arm of the rocker arm; and
implementing a lost motion by the inner rocker arm.

10. The method of claim 9, wherein a non-operation of the CDA by the control unit includes:
stopping an operation of the OCV by a CDA OFF signal output;
blocking the oil supply to one side of the rocker arm by blocking the primary oil line;
releasing a hydraulic pressure of the oil from the actuation pin of the rocker pin;
moving a latch pin of the rocker pin by a spring restoring force of a spring;
forming a primary pin engaged state of the inner pin of the rocker pin as the inner pin of the rocker pin is pushed to an initial position by the latch pin;
supplying the oil to an other side of the rocker arm by opening the secondary oil line;
moving the latch pin by the hydraulic operation of the oil; and
forming a secondary pin engaged state of the inner pin whose binding force is strengthened by the hydraulic operation.

11. The method of claim 9, wherein a non-operation of the CDA by the control unit includes:
stopping an operation of the OCV by a CDA OFF signal output;
blocking the oil supply to one side of the rocker arm by blocking the primary oil line;
releasing a hydraulic pressure of the oil from the actuation pin of the rocker pin;
supplying the oil to an other side of the rocker arm by opening the secondary oil line;
moving the latch pin by the hydraulic operation of the oil; and
forming a pin engaged state of the inner pin of the rocker pin at an initial position by the hydraulic operation.
